(19) United States
(12) Patent Application Publication
(10) Pub. No.: US 2012/0329404 A1
(43) Pub. Date: Dec. 27, 2012

(54) SURFACE-MOUNT SIGNAL TRANSCEIVER MODULE

(75) Inventor: Tsai-Yi YANG, Kuntien Township (TW)

(73) Assignee: Cirocomm Technology Corp.

(21) Appl. No.: 13/234,928

(22) Filed: Sep. 16, 2011

(30) Foreign Application Priority Data
Jun. 23, 2011 (TW) 100121936

(51) Int. Cl. H04B 1/38; H01Q 1/24

(52) U.S. Cl. 455/73; 343/702

(57) ABSTRACT

A surface-mount signal transceiver module includes an antenna unit (1), a metal casing (2), a circuit board (3) and a conductive element (4). The antenna unit (1) includes a base (11), a radiating metal plate (12) installed on surface of the base (11), a grounding metal plate (13) installed on the backside of the base (11), and a signal feed portion (14) disposed on the surface, lateral side and backside of the base (11). The metal casing (2) includes a platform (21) electrically coupled to the grounding metal plate (13), and an opening (24). The circuit board (3) includes a signal feed point (34) and at least one grounding portion (36) electrically coupled to the metal casing (2). The conductive element (4) is passed through the opening (24) and electrically contacted or electrically coupled between the signal feed portion (14) and the signal feed point (34), so that a non-needle shaped signal feed terminal is produced to simplify the structure of an antenna and facilitate the manufacture of the antenna.

### FIELD OF THE INVENTION

The present invention relates to an antenna, in particular to a signal transceiver module for transmitting and receiving signals.

### BACKGROUND OF THE INVENTION

In general, a conventional signal transceiver module 10A (as shown in FIG. 1) comprises: an antenna 1A, a metal casing 2A, a circuit board 3A and a signal feed element 4A. The antenna 1A has the needle-shaped signal feed element 4A directly passed through a base 11A, a radiating metal plate 12A, a grounding metal plate 13A of the of the antenna 1A and a metal casing 2A and electrically coupled to the radiating metal plate 12A and the circuit board 3A. After the radiating metal plate 12A has received a signal, the signal feed element 4A transmits the signal to the circuit board 3A for a signal processing or transmits the signal processed by the circuit board 3A from the signal feed element 4A to the radiating metal plate 12A, and then the radiating metal plate 12A radiates the signal to the outside.

Since the signal feed element 4A of the signal transceiver module 10A adopts a needle-shaped design, therefore the base 11A, the radiating metal plate 12A, the grounding metal plate 13A and the metal casing 2A require a plurality of through holes formed on their main bodies when the antenna 1A is manufactured, so that the signal feed element 4A can be passed through the base 11A, the radiating metal plate 12A, the grounding metal plate 13A and the metal casing 2A and electrically coupled to the circuit board 3A to form a signal feed terminal The signal transceiver module 10A of this sort generally has a more complicated structure and requires a cost and time consuming manufacture.

### SUMMARY OF THE INVENTION

Therefore, it is a primary objective of the present invention to overcome the aforementioned shortcomings by providing a non-needle shaped antenna, such that the signal transceiver module has a simpler structure and requires an easier manufacture.

To achieve the foregoing objective, the present invention provides a surface-mount signal transceiver module, comprising:

an antenna unit, having a base disposed thereon, a radiating metal plate disposed on a surface of the base, a grounding metal plate installed on a backside of the base, and a signal feed portion disposed on the surface, lateral and backside of the base;

a metal casing, having a platform electrically coupled to the grounding metal plate and an opening;

a circuit board, having a signal feed point and at least one grounding portion electrically coupled to the metal casing; and

a conductive element, passed through the opening and electrically contacted or coupled between the signal feed portion and the signal feed point.

Wherein, the base is made of ceramic.

Wherein, the platform of the metal casing includes a plurality of support plates extended from an edge of the platform and perpendicular to the platform, and each of the support plates has a joint portion.

Wherein, the opening is formed on a surface of the platform and any one of the support plates.

Wherein, the circuit board includes a wave filter and an amplifier installed thereon, and the wave filter is provided for filtering a noise included in the signal, and the amplifier is provided for amplifying and transmitting the filtered signal to the motherboard of the electronic device.

Wherein, the circuit board further includes a receiver module installed thereon and electrically coupled to the wave filter and the amplifier. After the signal is filtered and amplified, the signal is transmitted to the receiver module and processed by the receiver module, so that the electronic device can display related images or data of a global positioning system (GPS), and the receiver module is a circuit of the GPS.

Wherein, the circuit board includes at least one notch formed at an edge of the circuit board, and each notch corresponds to the grounding portion on the backside of the circuit board, and the joint portion of the support plate is bent or directly passed through the notch and electrically coupled to the grounding portion, and the circuit board includes at least one conductive portion disposed on the backside of the circuit board for electrically coupling the circuit board to the motherboard of the electronic device.

Wherein, the conductive element is made of metal into a line segment, a cylindrical form, an elastic plate or a spring.

To achieve the aforementioned objective, the present invention further provides a surface-mount signal transceiver module, comprising:

an antenna unit, having a base, a radiating metal frame disposed on a surface and a lateral side of the base, a signal feed portion disposed on the surface of the base, and a grounding metal plate installed at the surface, lateral side and backside of the base; and a circuit board, having a signal feed point and a grounding portion, and the signal feed point being electrically coupled to the signal feed portion of the base, and the base of the grounding portion being electrically coupled to the grounding metal plate.

Wherein, the base is made of plastic or ceramic.

Wherein, the radiating metal frame and the signal feed portion are formed by punching and etching a metal.

Wherein, the circuit board includes a wave filter and an amplifier, and the wave filter is provided for filtering a noise included in a signal, and the filtered signal is amplified by the amplifier and transmitted to the motherboard of the electronic device.

Wherein, the circuit board further includes a receiver module installed thereon and electrically coupled to the wave filter and the amplifier, and after the signal is filtered and amplified, the signal is transmitted to the receiver module and processed by the receiver module, so that the electronic device displays related images or data of a global positioning system (GPS), and the receiver module is a circuit of the GPS

Wherein, the circuit board includes at least one conductive portion disposed on the backside of the circuit board, and the conductive portion of the circuit board is electrically coupled to the motherboard of the electronic device.

### BRIEF DESCRIPTION OF THE DRAWINGS

FIG. 1 is an exploded view of a conventional signal transceiver module;

FIG. 2 is a perspective view of a signal transceiver module of the present invention;

FIG. 3 is an exploded view of a signal transceiver module of the present invention;

FIG. 4 is an exploded view at another angle of a signal transceiver module of the present invention;

FIG. 5A is a schematic circuit block diagram of a circuit board of the present invention;

FIG. 5B is a schematic circuit block diagram of another circuit board of the present invention;

FIG. 6 is a schematic view of a signal transceiver module coupled to a motherboard of an electronic device in accordance with the present invention;

FIG. 7 is a side view of a signal transceiver module coupled to a motherboard of an electronic device in accordance with the present invention; and

FIG. 8 is a perspective view of another signal transceiver module of the present invention.

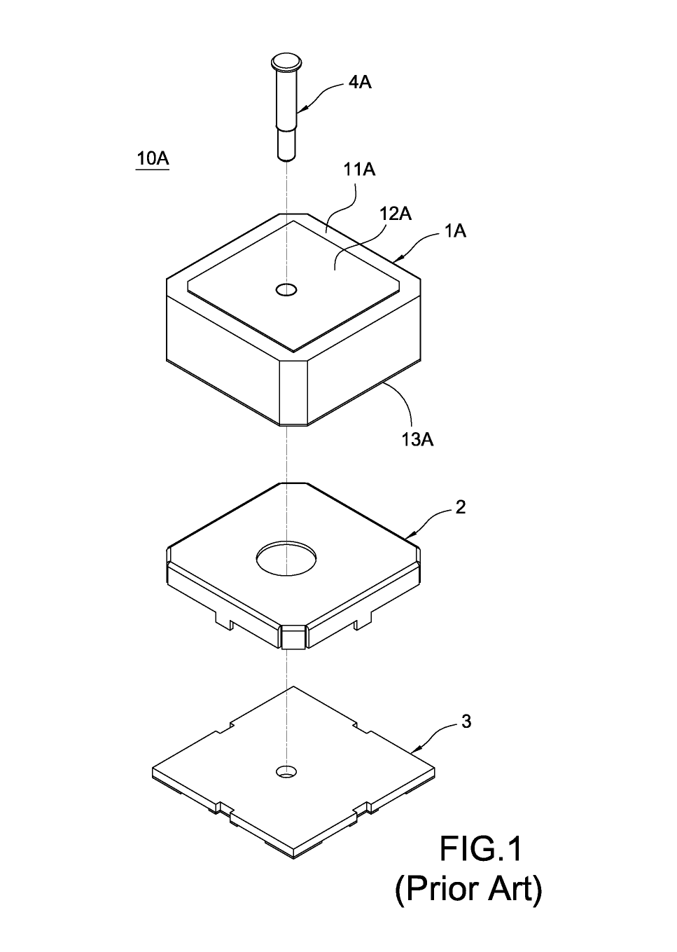

### DESCRIPTION OF THE PREFERRED EMBODIMENTS

The technical characteristics and contents of the present invention will become apparent with the following detailed description and related drawings. The drawings are provided for the purpose of illustrating the present invention only, but not intended for limiting the scope of the invention.

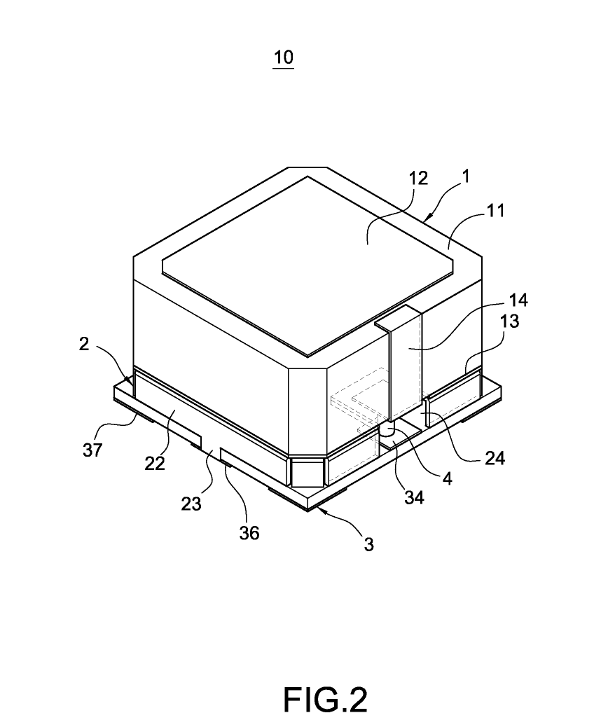

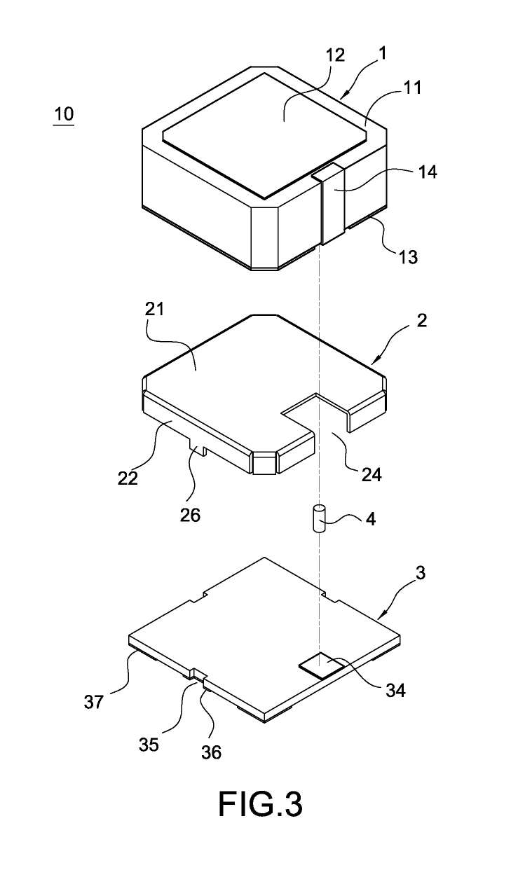

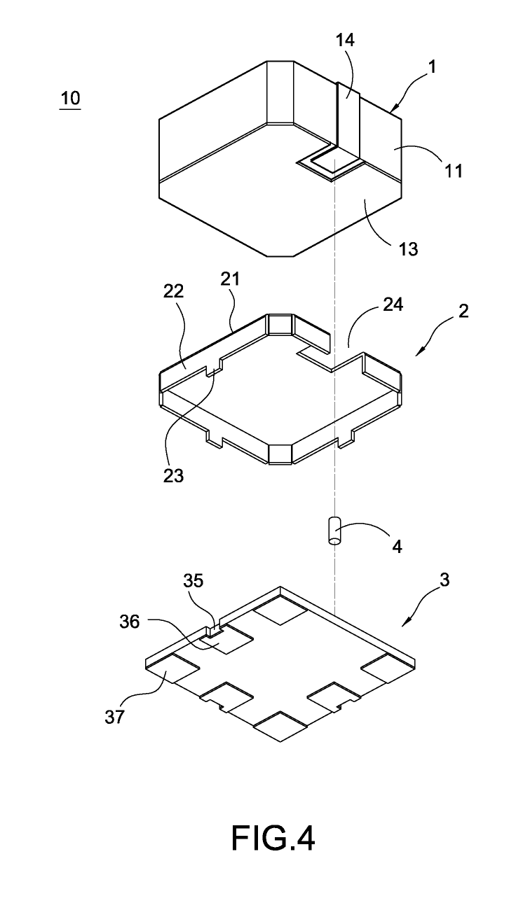

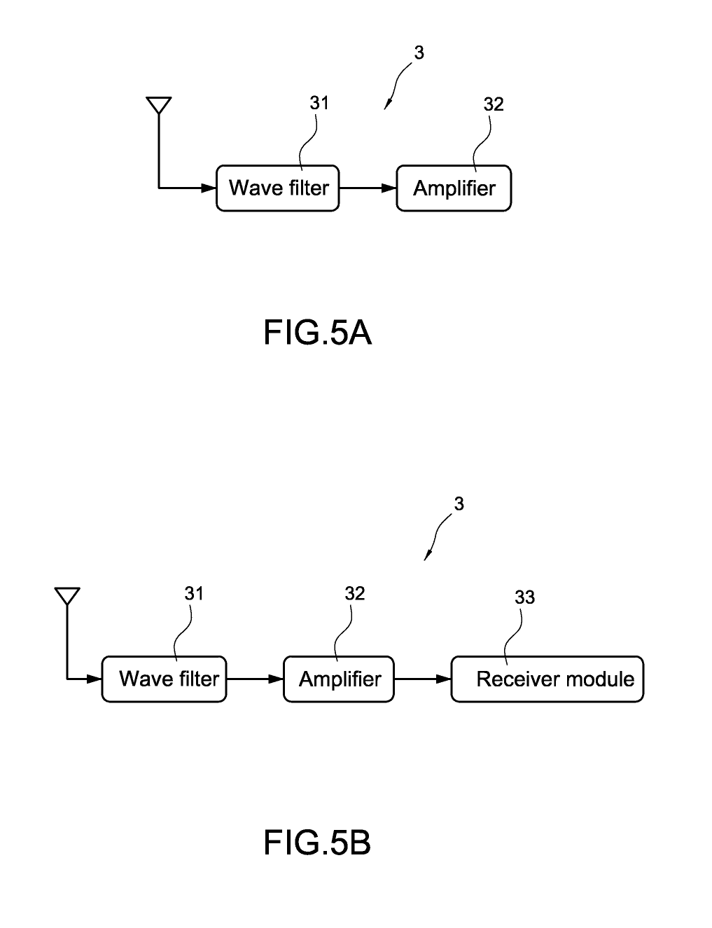

With reference to FIGS. 2, 3 and 4 for a perspective view and exploded views of a signal transceiver module of the present invention respectively, the signal transceiver module 10 comprises an antenna unit 1, a metal casing 2, a circuit board 3 and a conductive element 4.

The antenna unit 1 includes a base 11 made of ceramic, a radiating metal plate 12 installed on a surface of the base 11, a grounding metal plate 13 installed on the backside of the base 11, and a signal feed portion 14 disposed on the surface, lateral side and backside of the base 11, wherein the signal feed portion 14 is not coupled to the grounding metal plate 13, and the radiating metal plate 12 forms a signal transceiver terminal, and the signal feed portion 14 forms a signal feed terminal, and the signal feed portion 14 extended from the backside of the base 11 is electrically contacted or electrically coupled to the conductive element 4.

The metal casing 2 includes a platform 21, and the platform 21 has a surface electrically coupled to the grounding metal plate 13, a plurality of support plates 22 extended from an edge of the platform 21 and perpendicular to the platform 21, and each support plate 22 includes a joint portion 23 extended from the support plate 22 and bent or directly passed through a notch 35 of the circuit board 3 and electrically coupled to the grounding portion 36. Further, a surface of the platform 21 and any one of the support plates 22 have an opening 24, and the opening 24 is provided for passing the conductive element 4 and electrically contacting or electrically coupling the circuit board 3.

With reference to FIGS. SA and 5B for the circuit board 3, the circuit board 3 includes electronic components of a circuit, and the circuit comprises a wave filter 31 and an amplifier 32. The wave filter 31 is provided for filtering a noise included in a signal, and the filtered signal is amplified by the amplifier 32 and transmitted to a motherboard of an electronic device. The circuit board 3 further comprises a receiver module 33 (such as a circuit of a global positioning system (GPS)) manufactured with the wave filter 31 and the amplifier 32 on the same circuit board 3, and the wave filter 31 is provided for filtering a noise included in a signal. The filtered signal is amplified by the amplifier 32 and transmitted to the receiver module 33 for signal processing, and then the signal is transmitted to a motherboard of an electronic device (not shown in the figure), so that related images or data of a global positioning system (GPS) can be displayed by the electronic device. Further, the circuit board 3 also includes a signal feed point 34 on a front side of the circuit board 3, in addition to the electronic components (not shown in the figure), and the signal feed point 34 is provided for electrically contacting or electrically coupling the conductive element 4 to transmit the signal to the wave filter 31 and the amplifier 32, or transmit the signal to a circuit of the receiver module 33 (such as a circuit of the GPS), the wave filter 31 and the amplifier 32 for signal processing. Further, the circuit board 3 includes at least one notch 35 formed at an edge of the circuit board, and each notch 35 corresponds to a grounding portion 36 disposed on the backside of the circuit board 3, and the joint portion 23 on the support plate 22 is bent or directly passed through the notch 35 of the circuit board 3 and electrically coupled to the grounding portion 36. Further, the circuit board 3 includes at least one conductive portion 37 disposed on the backside of the circuit board 3, and the conductive portion 37 is provided for electrically coupling the circuit board 3 to a motherboard of the electronic device (not shown in the figure).

The conductive element 4 is made of metal into a line segment, a cylindrical form, an elastic plate or a spring, and the conductive element 4 is electrically contacted between the signal feed portion 14 on the backside of the base 11 and the signal feed point 34 of the circuit board 3 for feeding signals.

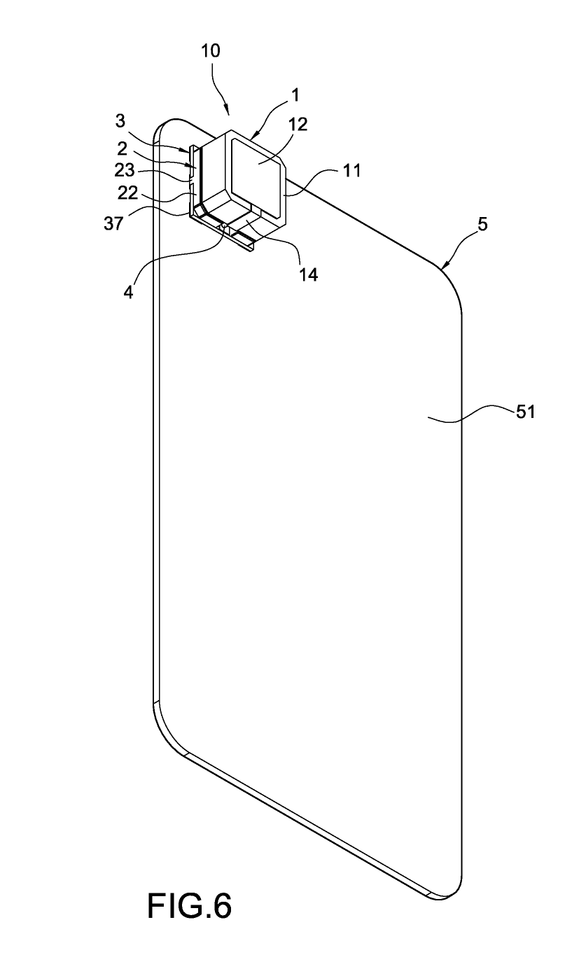

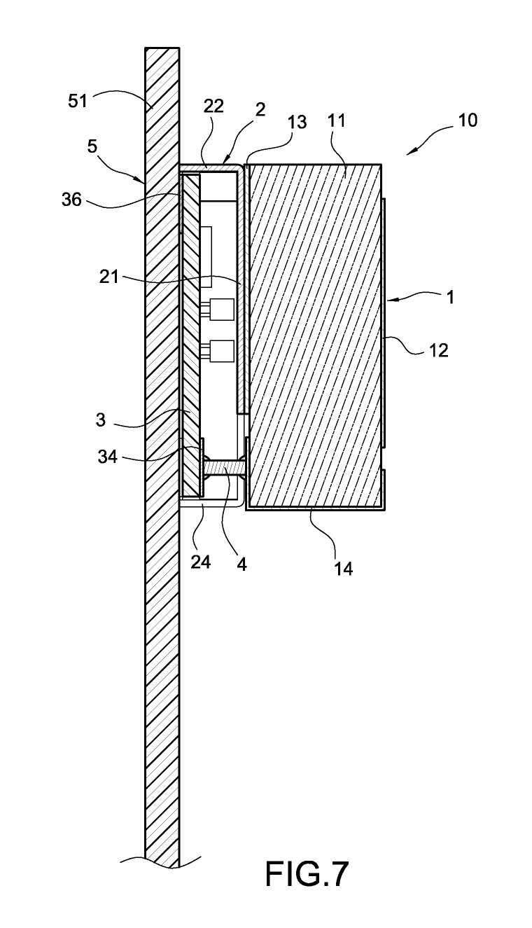

With reference to FIGS. 6 and 7 for a schematic view and a side view of a signal transceiver module coupled to a motherboard of an electronic device in accordance with the present invention respectively, the metal casing 2 is electrically coupled to the grounding metal plate 13 on the backside of the base 11, and the joint portion 23 disposed on the support plate 22 is installed into the notch 35 of the circuit board 3 and electrically coupled to the grounding portion 36. In the meantime, the conductive element 4 is electrically contacted or electrically coupled between the signal feed portion 14 of base 11 and the signal feed point 34 of the circuit board.

After the signal transceiver module 10 is installed, the conductive portion 37 disposed on the backside of the circuit board 3 is electrically coupled to the motherboard 51 of the electronic device, so that the signal transceiver module 10 is electrically coupled to a surface of the motherboard 51.

Since the signal transceiver module 10 is redesigned to skip the design of the conventional needle-shaped signal feed conductor and provide the signal feed terminal of the antenna, the whole signal transceiver module 10 has a much simpler structure and requires an easier manufacture, and the overall thickness of the signal transceiver module 10 becomes thinner, so as to comply with the requirements for a light, thin, short and compact design of the electronic product.

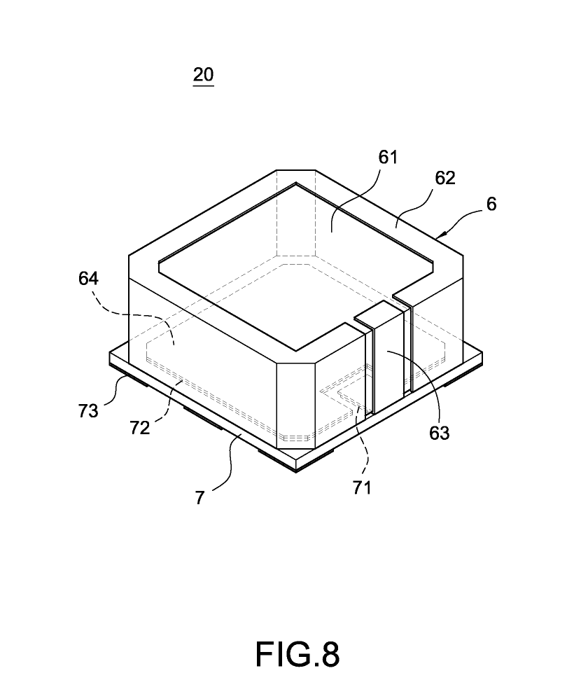

With reference to FIG. 8 for a perspective view of another signal transceiver module of the present invention, the signal transceiver module 20 of this embodiment includes an antenna unit 6 with a non-conductive base 61, wherein the base 61 is made of plastic or ceramic. Metal is punched or etched to form a radiating metal frame 62 and a signal feed portion 63, wherein the radiating metal frame 62 is covered and fixed onto a surface and a lateral side of the base 61, and the signal feed portion 63 is disposed on the surface, lateral side and backside of the base 61. Further, the base 61 includes a grounding metal plate 64 installed on the backside of the base 61, wherein the grounding metal plate 64 is not coupled to the signal feed portion 63 extended from the backside of the base 61, and the grounding metal plate 64 is electrically coupled to a grounding portion 71 of the circuit board 7, and the signal feed portion 63 is electrically coupled to a signal feed point 72 of the circuit board. Further, the circuit board 7 includes at least one conductive portion 37 for electrically coupling the circuit board 7 to a motherboard (not shown in the figure) of the electronic device. In FIG. 8, the circuit board 7 and the circuit board 3 have the same wave filter 31 and amplifier 32, or the same circuits of the receiver module 33 (such as a circuit of the GPS), the wave filter 31, and the amplifier 32.

The signal transceiver module 20 is covered onto the base 61 by the radiating metal frame 62 and the signal feed portion 63, so that the antenna unit 6 is directly and electrically coupled to the circuit board 7, and no metal casing 2 is required for the manufacture of the signal transceiver module 20. As a result, the whole signal transceiver module 20 has a simpler structure and requires an easier manufacture. The thickness of the whole signal transceiver module 20 becomes thinner to comply with the application of an electronic device (not shown in the figure) with a light, thin, short and compact design.

While the invention has been described by means of specific embodiments, numerous modifications and variations could be made thereto by those skilled in the art without departing from the scope and spirit of the invention set forth in the claims.

What is claimed is:

1. A surface-mount signal transceiver module, electrically coupled to a motherboard of an electronic device, comprising:
an antenna unit (1), having a base (11) disposed thereon, a radiating metal plate (12) disposed on a surface of the base (11), a grounding metal plate (13) on the backside of the base (11), and a signal feed portion (14) formed on the surface, lateral side and backside of the base (11);
a metal casing (2), having a platform (21) electrically coupled to the grounding metal plate (13), and an opening (24);
a circuit board (3), having a signal feed point (34) and at least one grounding portion (36) electrically coupled to the metal casing (2); and
a conductive element (4), passed through the opening (24) and electrically contacted or coupled between the signal feed portion (14) and the signal feed point (34).

2. The signal transceiver module of claim 1, wherein the base (11) is made of ceramic.

3. The signal transceiver module of claim 2, wherein the platform (21) includes a plurality of support plates (22) extended from an edge of the platform (21) and perpendicular to the platform (21), and each of the support plates (22) included a joint portion (23) extended from the support plate (22).

4. The signal transceiver module of claim 3, wherein the opening (24) is formed on a surface of the platform (21) and any one of the support plates (22).

5. The signal transceiver module of claim 4, wherein the circuit board (3) includes a wave filter (31) and an amplifier (32) installed thereon, and the wave filter (31) is provided for filtering a noise included in a signal, and the filtered signal is amplified by the amplifier (32) and transmitted to the motherboard of the electronic device.

6. The signal transceiver module of claim 5, wherein the circuit board (3) further includes a receiver module (33) installed thereon and electrically coupled to the wave filter (31) and the amplifier (32), and the wave filter (31) is provided for filtering a noise included in a signal, and the signal is filtered and amplified and then transmitted to the receiver module (33) and processed by the receiver module (33), so that related images or data of a global positioning system (GPS) of the electronic device are displayed.

7. The signal transceiver module of claim 6, wherein the receiver module (33) is a circuit of the GPS.

8. The signal transceiver module of claim 7, wherein the circuit board (3) includes at least one notch formed at an edge of the circuit board (3), and each notch corresponds to the grounding portion (36) disposed on the backside of the circuit board (3), and the joint portion (23) disposed on the support plate (22) is bent or directly passed through the notch and electrically coupled to the grounding portion (36).

9. The signal transceiver module of claim 8, wherein the circuit board (3) includes at least one conductive portion (37) disposed on the backside of the circuit board (3), for electrically coupling the circuit board (3) to the motherboard of the electronic device.

10. The signal transceiver module of claim 9, wherein the conductive element (4) is made of metal into a line segment, a cylindrical form, an elastic plate or a spring.

11. A surface-mount signal transceiver module, electrically coupled to a motherboard of an electronic device, comprising:
an antenna unit (1), having a base (11), a radiating metal frame disposed on a surface and a lateral side of the base (11), a signal feed portion (14) disposed on the surface of the base (11), and a grounding metal plate (13) installed at the surface, lateral side and backside of the base (11); and
a circuit board (3), having a signal feed point (34) and a grounding portion (36), and the signal feed point (34) being electrically coupled to the signal feed portion (14) of the base (11), and the base (11) of the grounding portion (36) being electrically coupled to the grounding metal plate (13).

12. The signal transceiver module of claim 11, wherein the base (11) is made of plastic or ceramic.

13. The signal transceiver module of claim 12, wherein the radiating metal frame and the signal feed portion (14) is formed by punching and etching a metal.

14. The signal transceiver module of claim 13, wherein the circuit board (3) includes a wave filter (31) and an amplifier (32), and the wave filter (31) is provided for filtering a noise included in a signal, and the filtered signal is amplified by the amplifier (32) and transmitted to the motherboard of the electronic device.

15. The signal transceiver module of claim 14, wherein the circuit board (3) further includes a receiver module (33) installed thereon and electrically coupled to the wave filter (31) and the amplifier (32), and after the signal is filtered and amplified, the signal is transmitted to the receiver module (33) and processed by the receiver module (33), so that the electronic device displays related images or data of a global positioning system (GPS).

16. The signal transceiver module of claim 15, wherein the receiver module (33) is a circuit of the GPS.

17. The signal transceiver module of claim 16, wherein the circuit board (3) includes at least one conductive portion (37) disposed on the backside of the circuit board (3), and the conductive portion (37) of the circuit board (3) is electrically coupled to the motherboard of the electronic device.
